(19) United States
(12) Patent Application Publication
(10) Pub. No.: US 2018/0014561 A1
(43) Pub. Date: Jan. 18, 2018

(54) MULTIGRAIN SNACK

(71) Applicant: S.H.R LTD. AGENCIES AND REPRESENTATIVE CONSUMER GOODS AND PACKAGING, Ra'anana (IL)

(72) Inventors: Rafi SHEFER, Kfar Saba (IL); Nissim SHLOMI, Hod Hasharon (IL)

(21) Appl. No.: 15/717,481

(22) Filed: Sep. 27, 2017

Related U.S. Application Data
(63) Continuation-in-part of application No. PCT/IL2016/050270, filed on Mar. 13, 2016.

(30) Foreign Application Priority Data
Apr. 2, 2015 (IL) 238298

(51) Int. Cl. A23L 7/122; A23L 5/10; A23L 33/10; A23P 30/20; A23L 27/00

(52) U.S. Cl. CPC A23L 7/122; A23L 5/10; A23P 30/20; A23L 27/00; A23L 33/10; A23V 2002/00

(57) ABSTRACT

The invention provides a multigrain snack exhibiting organoleptic properties of typical spicy snacks while containing health-promoting components of typical breakfast cereals meals. The snack can be a part of a low fat and healthy diet for common and safe consumption by any person, including a child.

### FIELD OF THE INVENTION

The present invention relates to the field of food manufacture and to the field of healthy diet. Particularly, the invention provides snacks for common and safe consumption by any person, including a child, in accordance with the principles of healthy nutrition.

### BACKGROUND OF THE INVENTION

Obesity is a major health problem in developed countries. The health problems associated with overweight include diabetes, cardiovascular diseases, arthritis, sleep disorders, and some forms of cancer. The overweight-related conditions cause half a million deaths in the USA alone, while contributing to economic losses of hundreds of billions dollars.

The weight control means include special physical activities, complex diets, drugs, and even surgeries, but prophylaxis is clearly the best choice. The average U.S. diet contains 37% of total calories as fat. The American Heart Association recommends that the proportion be reduced to 30%. This should be achieved by reducing the number of servings containing high percentage of fats and increasing the number of servings containing cereal and rice; the fat rich servings, less recommended for regular consumption, are graphically placed at the top of the food pyramid, whereas the recommended high number of cereals servings are placed at the bottom of said pyramid—called health food pyramid [The Merck Manual of Diagnosis and Therapy, 17th Ed., page 13, 1999]. Lowering daily caloric intake is usually painful; a preferred way would be to reduce the energetic content in the food items, and particularly in popular items. Even a minor reduction in the fat contents of popular food items would have a substantial effect in the overall dietary structure, and would be beneficial for general public health.

A substantial part of the human nutrition is constituted by cereals and their derivatives, wherein rice, maize and wheat provide about two thirds of world's food energy intake. In view of the increasing awareness of the risks associated with the consumption of saturated fats and cholesterol, and in view of the increasing demand for non-animal nutrition sources, the potential of the cereal product remains as high as ever. However, the cereal products include a broad range of items differing in the method by which the grain is processed during the food production, as well as in the ingredients with which the grain or its derivative is mixed; some products, such as breakfast cereals, are considered to be beneficial to human health, whereas many others, such as pieces having a high fat content and being processed at high temperatures are considered to be detrimental, particularly when consumed by children or in high quantities. There are many types of popular small food pieces, salty or sweet, ready for consumption, usually taken between main meals; they comprise, for example, potatoes or flour or popcorn, they are often processed at high temperatures and include ingredients conferring or imitating special flavors, such as, for example, flavors typical for fried meat products like barbecue or onion flavor. Examples of such snack pieces are deep fried potato or corn chips. The consumption of such products keeps increasing, both in adults and children, and may represent an important part of the daily caloric intake. It is therefore an object of this invention to provide a snack which would not be harmful even if consumed regularly by children or adults in high quantities.

It is another object of this invention to provide a snack based on healthy nutrition and intended for routine consumption of any person, including persons with health problems and children.

It is a still other object of this invention to provide a snack which would have a lowered caloric content when compared with other products of similar organoleptic properties.

It is further an object of the invention to provide a snack which would exhibit a taste, flavor and texture of popular snacks, but would have a significantly lower fat content.

It is also an object of the invention to provide a process for manufacturing snacks for common daily consumption by any person, including people with compromised health, overweight people, and children, the snacks complying with the principles of healthy nutrition.

It is also another object of the invention to provide a snack which would, according to the principal of healthy nutrition, belong near the bottom of the healthy food pyramid.

Other objects and advantages of present invention will appear as description proceeds.

### SUMMARY OF THE INVENTION

The present invention provides a multigrain snack product comprising a flake, wherein said flake comprises at least three kinds of cereals and an additive comprising a spicy or savory flavor and/or taste. In a preferred embodiment, said cereals kinds are selected from the group consisting at least of rice, corn, wheat, and oats. The multigrain snack of the invention preferably comprises less than 5% water and less than 5% fat. Where “%” is mentioned, “weight %” is intended. The multigrain snack product of the invention is a low-fat savory snack exhibiting i) the crunchiness and flavor of typical savory snacks; ii) the appearance of typical breakfast cereal flakes; and iii) the same content of beneficiary components as typical breakfast cereal flakes, including the contents of fibers and proteins. The multigrain cereal snack of the invention comprises flakes which are mechanically enough stable to keep their shape during packaging, storage, and transport of the product; the stability of the product is even enhanced by coating the flakes. Said additive comprises a spicy or savory flavor and/or taste selected from flavor and/or taste of onion, barbecue, meat, mixed meat, beef, lamb, game, fowl, chicken, fish, shrimp, ham, bacon, grill, smoke, sesame, cinnamon, pepper, salt and vinegar, sea salt and pepper, caramel salt, tomato, potato, potato chips, green chili, hot chili, sweet chili, olive, rosemary, oregano, cumin, mixed spice, mixed herbs, ranch salad dressing, mixed vegetable flavor, pizza, falafel, peanut, peanut butter, curry, wasabi, dairy, cheese, parmesan, butter, sour cream, or nacho. In a preferred embodiment of the invention, the additive is included in a coating essentially covering the whole surface of said flake. In other preferred embodiment of the invention, the additive is included in the whole volume of said flake. The snack preferably comprises at least one health-promoting component, for example selected from prebiotic saccharides. In a preferred embodiment, the multigrain snack of the invention, comprises carbohydrates at an amount of at least 75%, for example 80-85%. The multigrain snack of the invention preferably comprises energy at an amount of less than 430 kcal/100 g, for example less than 420 kcal/100 g, such as less than 410 kcal/100 g or less than 400 kcal/100 g or less than 390 kcal/100 g. In a preferred embodiment of the invention, the multigrain snack comprises energy at an amount of less than 380 kcal/100 g. The multigrain snack of the invention comprises usually sodium at an amount of less than 450 mg/100 g sodium, such as less than 400 mg/100 g or less than 350 mg/100 g. In a preferred embodiment of the invention, the multigrain snack comprises less than 400 kcal/100 g and less than 400 mg sodium/100 g. The multigrain snack of the invention comprises essentially no sodium monoglutamate. The multigrain snack of the invention preferably comprises no milk components, and is cholesterol free. In one aspect of the invention, the multigrain snack is constituted by extruded multi-cereal flakes, coated with a savory layer, comprising less than 4% water and less than 3% fat, which flakes exhibit organoleptic properties of typical spicy snacks while containing health-promoting components of typical breakfast cereals meals. In other aspect of the invention, the multigrain snack is constituted by extruded multi-cereal flakes containing a savory additive in the whole volume of the flake, comprising less than 4% water and less than 3% fat, which flakes exhibit organoleptic properties of typical spicy snacks while containing health-promoting components of typical breakfast cereals meals. In a preferred embodiment of the invention, the multigrain snack is a savory or spicy, salty snack containing less than 5% fats, having the appearance of typical breakfast cereals flakes. The savory snack product preferably comprises the healthy components of said three types of cereals and contains less than 5% fats, the product being stable on storage for at least 12 months. The multigrain snack of the invention preferably feels pleasant on fingers, without leaving oil or fine crumbles, its texture being pleasant in hands and in mouth.

The invention relates to a method for manufacturing a multigrain snack product exhibiting a savory flavor and/or taste, comprising the steps of i) providing ingredients derived from at least three cereals kinds, sugar, kitchen salt, edible emulsifiers, and optionally an additive comprising a spicy or savory flavor and/or taste, ii) mixing them with water, and optionally with other additives adjusting the molding behavior of the mixture, and the organoleptic properties of the product; iii) extruding and flaking the mixture obtained in step ii); iv) toasting the flakes obtained in step iii); v) optionally coating the toasted flakes with a coating aqueous mixture; the coating mixture may comprise additives conferring the product taste, flavor, or desired physical properties; vi) drying; and packaging and storing. In one aspect, the method of the invention comprises the steps of i) providing ingredients derived from at least three cereals kinds, sugar, kitchen salt, and edible emulsifiers, and mixing all components with water and optionally with other additives adjusting the molding behavior of the mixture and the organoleptic properties of the product; ii) extruding and flaking the mixture obtained in step i); iii) toasting the flakes obtained in step ii); iv) coating the toasted flakes with a coating aqueous mixture comprising oligofructans and seasonings conferring to the flakes a desired flavor; v) drying; and vi) packaging and storing. In a preferred embodiment, the method according to the invention comprises the steps of i) providing ingredients derived from at least three cereals kinds, sugar, kitchen salt, edible emulsifiers, and an additive comprising a spicy or savory flavor and/or taste, and mixing all components with water and optionally with other additives adjusting the molding behavior of the mixture and the organoleptic properties of the product; ii) extruding and flaking the mixture obtained in step i); iii) toasting the flakes obtained in step ii); iv) optionally coating the toasted flakes; v) drying; and vi) packaging and storing. The method of the invention preferably avoids a step of frying or heating at a high concentration of fat and at a high temperature, or a step of popping with oil. The method of the invention employs the step of cooking. The ingredients in said step i) are usually selected from rice, wheat, barley, oats, rye, whole wheat, wheat flour, barley malt extract, mono- and di-glycerides of edible fatty acids.

The invention preferably provides a savory multigrain snack product constituted by extruded multi-cereal flakes comprising a savory additive, less than 4% water, and less than 3% fat, which flakes exhibit organoleptic properties of typical spicy snacks while containing health-promoting components of typical breakfast cereals meals.

### DETAILED DESCRIPTION OF THE INVENTION

It has now been found that the typical cereals can provide a snack of the same organoleptic properties as the typical popular snacks of savory flavor usually based on flour and plant oil. Such savory snacks are crispy or crunchy and popularly have flavor of barbecue or onion, or other spicy taste and flavor, including taste or flavor of meat, mixed meat, grill, beef, lamb, game, fowl, chicken, fish, shrimp, ham, bacon, smoke, pepper, sesame, cinnamon, tomato, potato, green chili, mixed spice, mixed herbs, ranch salad dressing, mixed vegetable flavor, dairy, cheese, parmesan, butter, nacho, and others. Such popular snacks are consumed between two meals or with a beverage like soft drinks or beer or wine or others, often they are consumed several times a day or even continually and they may substantially contribute to a danger of overweight. The snacks are very popular with children. The present invention now provides snacks of the same savory flavor and texture as the existing high-energy snacks, with a possibility to offer any flavor from the broad spectrum of popular flavors, but with much lower fat content and with lower energetic content, and further without admixtures and ingredients considered to be undesired or harmful. Some ingredients, even though broadly employed in the food products, turn out to be potentially harmful, particularly if consumed in high quantities, or if consumed by sensitive individuals; MSG belongs among such ingredients, and the multigrain snack of the invention is MSG free despite its savory or spicy flavor. The snacks exhibiting the popular savory flavor according to the invention may have an appearance of the popular savory snacks or they may be prepared to have any desired appearance; in a preferred embodiment, the is savory snack of the invention has an appearance of healthy breakfast cereals and contains the healthy components of typical healthy breakfast cereals. In a preferred embodiment, the savory snack of the invention has a flavor and crunchiness of typical spicy snacks. In a preferred embodiment, the multigrain savory snack of the invention exhibits a crunchiness which is greater than the crunchiness of typical breakfast cereal flakes; the process of the invention for manufacturing the multigrain savory snack comprises providing a mixture of ingredients including at least three cereal kinds, while preferably avoiding some of the ingredients usually included in typical breakfast cereal flakes. In some embodiments of the invention, the preferred mixture of the ingredients avoids including at least some ingredients in the group consisting of wheat gluten, milk powder, starch, and raising agents; in a preferred embodiment, the mixture avoids all recited ingredients. The preferred mixtures of ingredients, possibly together with a preferred coating mixture, provide the desired degree of crunchiness.

Breakfast cereals, often served with milk or yogurt, belong among recommended, healthy items. It would be advantageous, in accordance with the modern principles of healthy nutrition, to consume them more often than only in the morning. On the other hand, the consumption of the popular savory-flavored high-caloric, fat-rich snacks should be reduced and consumed more rarely, according to the same principles. The instant invention will facilitate such increasing in the consumption of the healthy cereals while simultaneously decreasing the consumption of the unhealthy fat-rich snacks; this will be achieved by masking “good” cereals under a coating of “bad” snacks. Healthy cereals from the bottom of the pyramid will imitate popular snacks from its top; the snack of the invention, even though apparently spicy or savory, has a composition of items recommended for repeated consumption during a day. The nutritious grain item, usually served as a sweet morning meal, is in one embodiment of the invention converted to a product exhibiting savory flavor and texture of the existing high-energy snacks, or is in other embodiment of the invention converted to a product having an appearance of is a sally spicy snack, while in both cases keeping its beneficiary properties of a typical cereal breakfast product. This is achieved by employing several novel steps in processing the multigrain items, including providing a seasoning mixture comprising a desired snack flavor without including MSG and other spicy components of typical savory products, and coating the multi-cereal base with said seasoning mixture and drying, whereby mechanically stabilizing the cereals aggregates and conferring to them consistency of crunchy snack pieces. The product of the invention differs from existing breakfast cereal products by stronger structure and by savory aroma, and from existing spicy snacks it differs by containing the healthy multigrain mixture without accompanying excessive oil, MSG and other spicy ingredients. In one embodiment of the invention, the multigrain snack of the invention lacks undesired products of high-temperature processing steps like high temperature baking, roasting, deep frying, or popping with oil, which adds still more to the healthy character of the item. Combining popularity of the snacks with healthiness of the cereals addresses the serious problems associated with increased consumption of so called “junk food” and with overweight in children and adults.

The multigrain cereal snack of the invention has all the advantages of the healthy breakfast meal, including the fibers contained in the breakfast cereals, while lacking unhealthy components of typical savory snacks which contain fats in amounts of more than 10%, usually more than 20%, and often up to 35%, and harmful products being formed at excessively high processing temperatures. The snack of the invention preferably avoids undesired items, such as allergenic components; for example, in some embodiments, the multigrain snack of the invention exhibits flavor of peanuts but does not comprise any peanut-derived components, or in other embodiment the snack of the invention exhibits flavor of a milk or cheese product but does not comprise any milk-derived components.

The multigrain snack of the invention usually contains more than two cereal kinds. The snack usually contains components derived from said cereal kinds. Preferably, components from at least three cereal kinds are included.

The cereal kinds may comprise rice, wheat, barley, oats, and others. The multigrain snack of the invention preferably comprises less than 5% water and less than 5% fat, preferably less than 4% water and 4% fat. The snack may comprise less than 3.7% water, for example about 3.5%; the snack may comprise less than 3.5% fat, such as less than 3.0%, or less than 2.5%, or less than 2.0%, for example less than 1.8% or about 1.7%. The snack of the invention preferably comprises at least 75% carbohydrates, of which sweet sugars constitute at most 10%, for example at most 8%. The energetic content of the snack of the invention is usually less than 430 kcal/100 g, preferably less than 400 kcal/100 g. The sodium content of the snack according to the invention is less than 450 mg/100 g, preferably less than 400 mg/g. The snack of the invention preferably does not comprise monosodium glutamate. The snack preferably does not contain milk components, and is essentially cholesterol free. In one embodiment of the invention, the multigrain snack is milk free, cholesterol free, and MSG free. In other embodiments of the invention, the multigrain snack may be free of yeast, dried vegetables, or soy components.

The method of manufacturing the product of the invention usually comprises steps of mixing ingredients, extrusion, flaking, toasting, coating, and drying. In one embodiment of the invention, the process of manufacturing multigrain snack product comprises a step of cooking at least a part of the grain, or cooking at least one of cereals types, followed by a step of tempering. The process comprises a step of homogenizing the ingredients in a mixture, wherein the ingredients comprise components originating from at least three cereal types and water, the step usually comprising the use of an extruder, the mixture being exposed in the extruder to a higher temperature and pressure. In one aspect of the invention, the mixture comprises the needed seasonings; in another aspect of the invention the seasonings are present in the final coating. In another embodiment of the invention, the extruder provides pellets which are subsequently flaked in crushing rollers, the resulting flakes being toasted at higher temperature in a toasting machine, is thereby providing flakes. In a preferred embodiment of the invention, the flakes are coated with a liquid coating mixture containing the desired seasonings, for example in a coating drum, followed by drying in a dryer at a temperature of up to 100° C. The dried product may be sieved to obtain required particle size distribution. The product has preferably the form of flakes, for example having the shape of irregular flat ovals having a width of between 1 and 4 cm and a thickness of between 0.3 and 2 mm.

The typical known savory or spicy snacks are manufactured in a process comprising steps of frying or heating at a high concentration of fat and at a high temperature, or popping with oil. The invention provides a process of making a multigrain snack product exhibiting a savory flavor and/or taste, which process avoids frying or heating at a high concentration of fat and at a high temperature.

The number of ingredients mixed for said step of extrusion may be relatively small, for example seven, except for the seasoning additive. In one aspect of the invention, said seasonings are added to the mixture before extrusion; in other aspect of the invention, said seasonings are included in the coating mixture employed after the extrusion. Either said mixture before finishing the extrusion or said coating which covers the extruded core comprises seasonings which confer to the product any desired flavor. The mixture before finishing the extrusion may comprise health-promoting component(s) and/or structure-affecting components. In a preferred embodiment of the invention, the coating comprises seasonings, health-promoting component(s), and the structure affecting components. The coating mixture is specially designed and can be modified in accordance with the required flavor of the multigrain snack. The coating mixture preferably comprises at least one health-promoting component, such as micronutrients, metals, vitamins, or prebiotics. In a preferred embodiment, the health-promoting component comprises a prebiotic component, such as a saccharide, oligosaccharide or polysaccharide which is not digested by human gastrointestinal enzymes but stimulates the growth or activity of health-promoting bacteria. In one preferred embodiment, the coating of the multigrain snack comprises an oligofructan.

In a preferred embodiment of the invention, the coating lacks oil and comprises oligofructans and wheat starch, beside the seasonings. In one embodiment, the coating components include water and the coating mixture is sprinkled or sprayed on the product cereals extruded core in an amount of 3 to 10 wt % of the extruded core, when considering dry weights, usually about 5 to 6 wt %. The coating mixture may contain, for example, 66 wt % water, 7 wt % oligofructose, 24 wt % flavorings, 2 wt % wheat starch, and 1 wt % salt, and may be sprinkled on the extruded core at an amount of about 20 wt % (wet weight). In another embodiment, a final product of the multigrain snack of the invention may comprise 1.6 wt % fructans, 0.4 wt % starch, 3 wt % flavorings, and 0.2 wt % kitchen salt

The high-fat snack as prepared by known methods are highly problematic from the viewpoint of modern healthy nutrition, and their amount in the daily food portion should be restricted as much as possible. Another drawback of the high-fat content in said known snacks is their susceptibility to oxidation, resulting in reduced stability on storage and to an increased risk of inadvertent consumption of rancid products. Whereas the known snacks exhibit the storage stability of typically between 3 and 9 months, the healthy snack of the invention has usually a storage stability of 12 months and more. A further feature of the known high-fat snack is a not too pleasant oily feeling on fingers and in mouth left by the consumed pieces; the snack of the invention does not leave the oily feeling on fingers and in mouth, it leaves a dry and pleasant feeing on touch. Many known snacks exhibit a dusty coating which releases fine crumbs, being felt on the fingers and being often scattered around; the snack of the invention feels compact and not crumby or crumbly. The snack of the feels pleasant on fingers, without leaving oil or fine crumbles.

The invention preferably provides a multigrain snack product comprising at least three cereals and a savory additive, the product containing less than 5% fat, having the appearance similar to typical breakfast cereals, and containing healthy components of typical breakfast cereals, while lacking the unhealthy components of typical high-fat savory snacks, wherein said additive confers to the product a spicy or savory flavor selected from flavor of barbecue, meat, mixed meat, beef, lamb, game, fowl, chicken, fish, shrimp, ham, bacon, grill, smoke, onion, sesame, cinnamon, pepper, salt and vinegar, sea salt and pepper, caramel salt, tomato, potato, potato chips, green chili, hot chili, sweet chili, olive, rosemary, oregano, cumin, mixed spice, mixed herbs, ranch salad dressing, mixed vegetable flavor, pizza, falafel, peanut, peanut butter, curry, wasabi, dairy, cheese, parmesan, butter, sour cream, or nacho.

In a preferred embodiment, the invention provides a savory or spicy, salty snack having the appearance of typical breakfast—usually sweet—cereals. The snack of the invention contains healthy components of typical breakfast cereals and lacks the unhealthy components of typical high-fat savory snacks. When relating to typical breakfast cereals appearance, intended is their usual flake-like shape and their golden color. Importantly, the snack of the invention comprises at least three types of cereals, less than 5% fats, preferably at least 75% carbohydrates, and it comprises less than 5% water and is crunchy.

The low-fat multigrain savory snack according to the invention differs from the known multigrain breakfast cereal flakes; it is crunchy and it has organoleptic properties of high-fat savory snacks. The low-fat multigrain savory snack according to the invention differs from the known savory snacks; its shape differs from the shape of the known high-fat savory snacks. The low-fat multigrain savory snack according to the invention has, in one preferred embodiment, exactly the same shape as the known multigrain breakfast cereal flakes. The low-fat multigrain savory snack according to the invention differs from the known multigrain breakfast cereal flakes in the composition; the known multigrain breakfast cereal flakes typically consist of at least 12 ingredients, the snack of the invention typically consists of 7 ingredients beside the additive incorporating a spicy or savory flavor and/or taste. The low-fat multigrain savory snack according to the invention is manufactured entirely differently than the known savory snacks; the manufacturing process of known savory snacks includes the step of frying, baking, or popping, whereas the process of the invention avoids exposing the item under production to high concentrations of oil, to high temperatures, or to air pressure changes. The multigrain savory snack according to the invention differs from the known savory snacks by its composition, by its shape, and by its production method. The multigrain savory snack according to the invention has typically the appearance of the beneficiary breakfast cereal multigrain flakes, and it comprises the beneficial components of said flakes, such as fibers and proteins. In a preferred embodiment, the process of manufacturing the multigrain savory snack of the invention employs an aqueous coating mixture comprising oligofructans and savory additives.

The invention will be further described and illustrated in the following examples.

### EXAMPLES

### Example 1

### Manufacturing Multigrain Snack

The food product and process in accordance with one embodiment of the invention may have the features as exemplified below.

Type of the product: onion-flavored snack in the shape of coins (irregular circles) of a naturally golden color.

Ingredients: 50% rice, 18% whole wheat, 17% rice flour, 4.2% sucrose, 0.5% is barley malt extract, 0.7% salt, 0.05% emulsifiers (mono- and di-glycerides of edible fatty acids).

Manufacturing process: steps of extrusion, flaking, toasting, coating with a flavoring mixture (6% seasonings, 3.8% oligofructans, in water), drying, packaging and storage.

Chemical Characteristics:

| | |
|---|---|
| Moisture | 3.5% |
| Proteins | 7.6% |
| Fat | 1.7% |
| Saturated fats | 0.4% |
| Carbohydrates | 83% |
| of which starch | 76% |
| of which sugars | 7% |
| Fiber | 3% |
| Ash | 3.3% |
| Sodium | 0.3% |
| Energy | 384 kcal/100 g |

Appearance and Sensorial Characteristics:

| | |
|---|---|
| Aspect | irregular flake |
| Size | 90% mass having a size between 2 and 4 cm |
| Color | light brown |
| Odor and taste | typical of onion-flavored snacks |

Microbiological Characteristics:

| | |
|---|---|
| Total count plate | ≦5000 ufc/g |
| Molds | ≦5000 ufc/g |
| Yeasts | ≦5000 ufc/g |
| Fecal coliforms | absent in 1 g |
| Salmonella | absent in 25 g |

Further Product Characteristics:

No artificial colors

No preservatives

No G.M.O. involved

No cholesterol

To be stored below 25° C.

### Example 2

### Manufacturing Multigrain Snack

The food product and process in accordance with one embodiment of the invention may have the following features.

A higher pressure and a higher temperature are employed to make the product, both assist the cereal starch to transform its structure. Rice is cooked in autoclaves for about 40 minutes, the temperature rising to 130° C. The cooked rice undergoes a “tempering process” in which the temperature decreases for about 2 hours. The ingredients for multigrain snack are placed to an extruder, including the rice, whole wheat, rice flour, barley malt extract, and salt. The pressure in the extruder is created by (a) heating the extruder elements, which generates steam inside the extruder machine, and (b) mechanical action of twin screw extruder. Irregular spherical pellets are obtained, having an irregular shape of about 1 cm across. The pellets are flaked in a specific machine provided with two rollers, resulting in flakes which undergo swelling inside a toasting machine at 240° C., followed by coating in a drum, the coating material comprising water, oligofructan, and seasoning, coated on the surface of the flakes having about 4% moisture. The coated flakes are dried in a dryer to remove excess water at 80-100° C. for about 15 minutes. The final flakes, having the form of golden irregular ovals having a size of between 2-4 cm, are controlled for size, absence of metallic particles, and are packed.

### Example 3

### Comparing the Multigrain Snack with a Typical Onion-Flavored Snack

The snack as described in Example 1 above, was compared with typical onion-flavored snacks as available on the market, and some of the results are in Table 1.

TABLE 1
Comparison of a snack according to one embodiment of the
invention with typical snacks existing on the market

| Feature | Invention snack | Existing snack |
|---|---|---|
| Hardness | Strong, crunchy | Strong, crunchy |
| Odor | Pleasant onion | Pleasant onion |
| Number of cereals kinds | 3 | 1 |
| Number of ingredients | 7 | 8-9 |
| Fat % | 1.7 | 20-35 |
| Carbohydrates % | 83 | 44-66 |
| Sodium mg/100 g | 300 | 450-750 |
| Energy kcal/100 g | 384 | 480-560 |
| Rice or oats or barley ^{#} | + | − |
| MSG | − | + |
| Plant oil | ± | + |
| Yeast or dried vegetables or soy | ± | + |

^{#} The sign + denotes presence of a component, the sign − denotes absence, and the sign ± denotes usual low concentration or absence.

The comparison shows that the snack according to the invention has all the organoleptic features typical for popular savory-flavored snacks which are considered to be near the top of the healthy food pyramid and are not recommended for regular consumption, the features including the texture, feeling in mouth, crunchiness, appearance, odor and taste.

Whereas the snack has organoleptic properties of the typical snack, it has nutrition features typical for the breakfast cereals which are considered to be near the bottom of the healthy food pyramid and are highly recommended for frequent consumption to all people including ill people and convalescents, is people with overweight, and children. The consumers will consume the snacks of the invention with the same pleasure as they consume the existing typical spicy and highly caloric, fat-rich snacks. Thus, in many situations, the multigrain snack according to the invention will advantageously replace the typical flour and oil snacks, while providing recommended components with much less oil and less calories.

While this invention has been described in terms of some specific examples, many modifications and variations are possible. It is therefore understood that within the scope of the appended claims, the invention may be realized otherwise than as specifically described.

1. A multigrain snack product comprising a flake, wherein said flake comprises at least three kinds of cereals and an additive comprising a spicy or savory flavor and/or taste.

2. The multigrain snack of claim 1, wherein said cereals kinds are selected from the group consisting at least of rice, corn, wheat, and oats.

3. The multigrain snack of claim 1, comprising less than 5% water and less than 5% fat.

4. The multigrain snack product of claim 1, being a low-fat savory snack exhibiting
i) the crunchiness and flavor of typical savory snacks;
ii) the appearance of typical breakfast cereal flakes; and
iii) the same content of beneficiary components as typical breakfast cereal flakes, including the contents of fibers and proteins.

5. The multigrain snack of claim 1, wherein said flakes keep their shape during packaging, storage, and transport of the product.

6. The multigrain snack of claim 1, wherein said additive comprises a spicy or savory flavor and/or taste selected from flavor and/or taste of barbecue, meat, mixed meat, beef, lamb, game, fowl, chicken, fish, shrimp, ham, bacon, grill, smoke, onion, sesame, cinnamon, pepper, salt and vinegar, sea salt and pepper, caramel salt, tomato, potato, potato chips, green chili, hot chili, sweet chili, olive, rosemary, oregano, cumin, mixed spice, mixed herbs, ranch salad dressing, mixed vegetable flavor, pizza, falafel, peanut, peanut butter, curry, wasabi, dairy, cheese, parmesan, butter, sour cream, or nacho.

7. The multigrain snack of claim 1, wherein said additive is included in a coating essentially covering the whole surface of said flake.

8. The multigrain snack of claim 1, wherein said additive is included in the whole volume of said flake.

9. The multigrain snack of claim 1, comprising at least one health-promoting component.

10. The multigrain snack of claim 1, comprising at least one health-promoting component selected from prebiotic saccharides.

11. The multigrain snack of claim 1, comprising carbohydrates at an amount of at least 75%.

12. The multigrain snack of claim 1, comprising energy at an amount of less than 430 kcal/100 g.

13. The multigrain snack of claim 1, comprising energy at an amount of less than 380 kcal/100 g.

14. The multigrain snack of claim 1, comprising sodium at an amount of less than 450 mg/100 g.

15. The multigrain snack of claim 1, comprising less than 400 kcal/100 g and less than 400 mg sodium/100 g.

16. The multigrain snack of claim 1, comprising essentially no sodium monoglutamate.

17. The multigrain snack of claim 1, comprising essentially no milk components.

18. The multigrain snack of claim 1, constituted by extruded multi-cereal flakes, coated with a savory layer, comprising less than 4% water and less than 3% fat, which flakes exhibit organoleptic properties of typical spicy snacks while containing health-promoting components of typical breakfast cereals meals.

19. The multigrain snack of claim 1, constituted by extruded multi-cereal flakes containing a savory additive in the whole volume of the flake, comprising less than 4% water and less than 3% fat, which flakes exhibit organoleptic properties of typical spicy snacks while containing health-promoting components of typical breakfast cereals meals.

20. The multigrain snack of claim 1, being a savory or spicy, salty snack containing less than 5% fats, having the appearance of typical breakfast cereals flakes.

21. The savory snack product of claim 1, comprising the healthy components of said three types of cereals and containing less than 5% fats, the product being stable on storage for at least 12 months.

22. The multigrain snack of claim 1, feeling pleasant on fingers, without leaving oil or fine crumbles.

23. A method for manufacturing a multigrain snack product exhibiting a savory flavor and/or taste, comprising the steps of
i) providing ingredients derived from at least three cereals kinds, sugar, kitchen salt, edible emulsifiers, and optionally an additive comprising said savory flavor and/or taste, and mixing all components with water and optionally with other additives adjusting the molding behavior of the mixture, and the organoleptic properties of the product;
ii) extruding and flaking the mixture obtained in step i);
iii) toasting the flakes obtained in step ii);
iv) optionally coating the tasted flakes with a coating aqueous mixture;
v) drying; and
vi) packaging and storing.

24. The method of claim 23, comprising the steps of
i) providing ingredients derived from at least three cereals kinds, sugar, kitchen salt, and edible emulsifiers, mixing them with water and optionally with other additives adjusting the molding behavior of the mixture, and the organoleptic properties of the product;
ii) extruding and flaking the mixture obtained in step i);
iii) toasting the flakes obtained in step ii);
iv) coating the toasted flakes with a coating aqueous mixture comprising oligofructans and seasonings conferring to the flakes said savory flavor and/or taste;
v) drying; and
vi) packaging and storing.

25. The method of claims 23, comprising the steps of
i) providing ingredients derived from at least three cereals kinds, sugar, kitchen salt, edible emulsifiers, and an additive comprising said spicy or savory flavor and/or taste, mixing them with water and optionally with other additives adjusting the molding behavior of the mixture, and the organoleptic properties of the product;
ii) extruding and flaking the mixture obtained in step i);
iii) toasting the flakes obtained in step ii);
iv) optionally coating the toasted flakes with a coating aqueous mixture;
v) drying; and
vi) packaging and storing.

26. The method of claim 23, comprising cooking.

27. The method of claim 23, avoiding frying, heating at a high concentration of fat, heating at a high temperature, or popping with oil.
